(19) United States
(12) Patent Application Publication
(10) Pub. No.: US 2025/0188282 A1
(43) Pub. Date: Jun. 12, 2025

(54) Green high viscosity toughness asphalt modifier, modified asphalt, bituminous concrete and preparation methods thereof

(71) Applicant: Changsha University of Science & Technology, Changsha (CN)

(72) Inventors: Chengdong Xia, Changsha (CN); Dikuan Wang, Changsha (CN); Songtao Lv, Changsha (CN); Zhen Leng, Changsha (CN); Jianlong Zheng, Changsha (CN)

(21) Appl. No.: 19/059,833

(22) Filed: Feb. 21, 2025

(30) Foreign Application Priority Data
Mar. 18, 2024 (CN) 2024103046405

(51) Int. Cl. C08L 95/00; C08J 3/22; C08K 9/04; C08L 17/00; C08L 23/06; C08L 23/12

(52) U.S. Cl. CPC C08L 95/00; C08J 3/226; C08K 9/04; C08L 17/00; C08L 23/06; C08L 23/12; C08J 2395/00; C08J 2417/00; C08J 2423/06; C08J 2423/12; C08L 2205/025; C08L 2205/035; C08L 2205/08; C08L 2207/20; C08L 2207/322; C08L 2310/00; C08L 2555/86

(57) ABSTRACT

A green high viscosity toughness asphalt modifier includes following raw material components by weight: 70-232 parts of waste rubber and plastic mixture; 4-10 parts of nano-clay material; and 15-50 parts of compatilizer. A preparation method of the green high viscosity toughness asphalt modifier includes steps of (1) preparing masterbatch by a first melt blending extrusion, which includes weighing the nano-clay material, the waste rubber and plastic mixture and the compatilizer in accordance with a weight ratio of 1:(2-4):(1-2), mixing evenly at high speed, extruding and granulating for obtaining the masterbatch; and (2) performing a second melt blending extrusion, which includes mixing evenly the waste rubber and plastic mixture, the masterbatch obtained by the step (1) and the compatilizer with a weight ratio of (5-9):(1-5):(1-3) at high speed, extruding and granulating for obtaining the asphalt modifier.

### CROSS REFERENCE OF RELATED APPLICATION

The present invention claims priority under 35 U.S.C. 119(a-d) to CN 202410304640.5, filed Mar. 18, 2024.

### BACKGROUND OF THE PRESENT INVENTION

### Field of Invention

The present invention relates to the technical field of bituminous concrete for road engineering, specifically to a green high viscosity toughness asphalt modifier, modified asphalt, bituminous concrete and preparation methods thereof, and more particularly to a green high viscosity toughness asphalt modifier, modified asphalt, bituminous concrete and preparation methods thereof suitable for very heavy, extra heavy, heavy traffic.

### Description of Related Arts

More than 95% of existing highways are asphalt pavements in China. As one of the main raw materials for asphalt pavements, petroleum asphalt is a mixture of some extremely complex polymer hydrocarbons and non-metallic (oxygen, sulfur, nitrogen) derivatives of these hydrocarbons which are formed by petroleum under natural environmental conditions and subjected to geophysical factors for a long time. However, due to the common and serious overloading and heavy loading of highways, the pavement, especially the asphalt surface layer, is also subject to the repeated effect of the harsh climatic environment such as large temperature difference, freezing rain and snow, and strong ultraviolet light, causing frequent diseases such as pavement cracking and rutting. According to current standards in China, the design life of highway asphalt pavement is 15 years. However, through research, it is found that more than 70% of highways need large and medium repairs after about 10 years of use, and the life is much lower than that of European and American countries, resulting in huge resource and energy consumption, serious environmental pollution damage, and hindering the sustainable development of highways. The performance of traditional matrix asphalt is difficult to meet the demand of increasing traffic volume. Therefore, the research and development of high-performance asphalt has been paid more and more attention by road workers, and it is the most important way to obtain high-performance asphalt by improving the matrix asphalt with asphalt modifiers.

SBS (styrene-butadiene-styrene triblock copolymer) is a commonly used asphalt modifier. SBS modifier is able to obviously improve the weather fastness, load resistance, low temperature flexibility, high temperature fluidity and other properties of asphalt, and is able to greatly improve the performance of asphalt and prolong the service life of asphalt. Therefore, it has been widely used in prior art.

For example, the Chinese patent document CN 108034270A discloses a modified asphalt and its preparation method. The modified asphalt is prepared from following raw material components by weight: 100-120 parts of asphalt, 6-20 parts of modifier, 3-9 parts of compatilizer, 0.15-0.25 parts of sulphur, 0.4-0.6 parts of non-amine anti-stripping agent and 0.2-0.4 parts of coupling agent. The modifier contains SBS (styrene-butadiene-styrene triblock copolymer), rubber and polyurethane. A high viscosity modified asphalt for permeable asphalt pavement system is prepared by combining high-speed shear with colloid mill. The modified asphalt provided by this scheme is able to simultaneously meet the following requirements: elastic recovery at 25° C.≥98%, dynamic viscosity at 60° C.≥500,000 Pa·s, composite shear modulus at 60° C.≥10 kPa, and critical temperature of G*/Sin δ≥2.2 kPa≥94° C.

The Chinese patent document CN 115304925A discloses a low melting point instant soluble high viscosity asphalt modifier and its preparation method. The asphalt modifier is prepared from the following raw material components by weight: 8-15 parts of MG-Al dihydroxyl composite metal hydroxide, 12-14 parts of antioxidant, 10-15 parts of heavy aromatic oil, 0.4-2 parts of silane coupling agent, 40-60 parts of SBS rubber powder, 0.01-0.05 parts of graphene, 20-25 parts of aromatic extract oil, 3-10 parts of tetraethyl silicate, and 12-21 parts of modifier.

The above two existing technical solutions take SBS and rubber as the main components of the modifier. On the one hand, since the production of SBS modifier involves petrochemical raw materials, it is unsustainable and costly. In addition, SBS modifier has a C═C double bond, which is easy to age, so that it easily leads to a sharp decline in performance. On the other hand, rubber modified asphalt has too much viscosity at high temperature, which is difficult to ensure the construction workability. Moreover, the porosity of permeable asphalt pavement system is very large (about 15%-25%). If the high viscosity asphalt disclosed by CN 108034270A is used in the permeable asphalt pavement system, the high viscosity asphalt is easy to contact with the air, which will reduce the service performance of the high viscosity permeable asphalt pavement. CN 115304925A also discloses that graphene is added as a modified material. Graphene is a very expensive material, which will further increase the cost of high viscosity modifier, thus affecting its practical applications.

In order to solve the problems existing in the above SBS/rubber asphalt modifier, it is proposed in the prior art that nano materials and waste rubber powder are used for modification, which is able to solve the problem of high cost of SBS/rubber modification.

For example, the Chinese patent document CN 107227031A discloses a nano-composite asphalt modifier and its preparation method. The modifier includes the following raw material components by weight: 3-5 parts of the modified nanomaterials, 30-50 parts of thermoplastic styrene elastomer, 30-40 parts of recycled rubber powder, 20-40 parts of recycled polyethylene material, and 1-2 parts of curing agent. Maleic anhydride grafted PE is 1.5%-3% of the amount of recycled polyethylene material. This document improves the lipophilicity of the nano material and the dispersibility of the nano material in asphalt by first treating the surface of nano material. The addition of the nano material in the modifier is able to further improve the high and low temperature stability of the modified asphalt with the modifier of the document.

According to the requirements of JTG/T 3350-03-2020 specially marked in “Technical Specifications for Design and Construction of Drained Asphalt Pavement”, the dynamic viscosity of modified asphalt with high viscosity should be appropriately improved for extremely heavy, extra heavy and heavy traffic, and should be above 20 wPa·s. The most important index of high viscosity asphalt is the dynamic viscosity at 60° C., that is, for extremely heavy, extra heavy and heavy load traffic, the dynamic viscosity at 60° C. should be above 20 vwPa·s. The nano materials and waste rubber powder composite modifier, and the modified asphalt provided by the above prior art CN 107227031A refer to their public performance data, the dynamic viscosity at 60° C. in the best embodiment (Embodiment 3) is only 15.7 wPa·s, which is far from the viscosity requirements of very heavy, extra heavy and heavy load traffic, thus limiting the application of asphalt. In addition, although the composite modification of nano materials and waste rubber powder is able to solve the problem of high cost of SBS/rubber modification, due to the high specific surface energy and surface area of nano particles, it is easy for the nano particles to agglomerate with waste rubber powder during the mixing process, which will affect the dispersion and uniformity of the material, thus affecting the stability of the material and other properties.

Therefore, it is urgent to develop a high viscosity and performance asphalt modifier, modified asphalt, bituminous concrete and preparation method thereof with low cost, good stability, simple preparation and wide application range, which is especially suitable for extremely heavy, extra heavy and heavy load traffic, modified asphalt and its preparation method and asphalt concrete.

### SUMMARY OF THE PRESENT INVENTION

A technical problem to be solved of the present invention is to provide a green high viscosity toughness asphalt modifier, modified asphalt, bituminous concrete and preparation methods thereof. An object of the present invention is that in view of the problems existing in the high viscosity toughness asphalt of the prior art, nanomaterials are easy to agglomerate in asphalt, poor compatibility between waste rubber and plastic materials and asphalt, poor stability, high cost, unsustainable, narrow scope of application, poor construction workability, and difficult to effectively improve the comprehensive performance, by optimizing the formulation and preparation process of the modifier, the environmentally friendly raw materials are first adopted, and a green high viscosity asphalt modifier is prepared by creatively adopting secondary melt blending extrusion method, which better achieves the stripping of layered nano-clay materials, solves the problem that nano-clay materials are difficult to disperse in waste rubber and plastic materials, and finally realizes the research and development of low-cost green low-carbon high viscosity toughness modified asphalt and bituminous concrete.

To solve the above technical problems, the present invention adopts technical solutions as follows.

The present invention provides a green high viscosity toughness asphalt modifier, which includes following raw material components by weight:
70-232 parts of waste rubber and plastic mixture;
4-10 parts of nano-clay material; and
15-50 parts of compatilizer,
wherein the asphalt modifier is prepared by secondary melt blending extrusion method.

Preferably, the waste rubber and plastic mixture consists of waste rubber and waste plastics with a mass ratio in a range of 1:(0.8-1.5).

Preferably, the waste rubber is waste rubber powder mainly from waste tire rubber with a particle size in a range of 40 to 120 meshes, wherein a content of rubber hydrocarbon in the waste rubber is larger than 50%.

Preferably, the waste plastics are waste polyethylene particles or waste polypropylene particles with a particle size in a range of 10 to 15 meshes, wherein the particles are uniform and plump.

Preferably, the nano-clay material is at least one member selected from a group consisting of nano-organic montmorillonite, nano-rectorite, and nano-vermiculite.

Preferably, the compatilizer is aromatic oil with a content of aromatic hydrocarbon larger than 80%.

Preferably, the asphalt modifier is prepare by secondary melt blending extrusion method, which comprises steps of:
(1) preparing masterbatch by a first melt blending extrusion, which comprises weighing the nano-clay material, the waste rubber and plastic mixture and the compatilizer in accordance with a weight ratio of 1:(2-4):(1-2), mixing evenly at high speed, extruding and granulating for obtaining the masterbatch; and
(2) performing a second melt blending extrusion, which comprises mixing evenly the waste rubber and plastic mixture, the masterbatch obtained by the step (1) and the compatilizer with a weight ratio of (5-9):(1-5):(1-3) at high speed, extruding and granulating for obtaining the asphalt modifier.

Preferably, in the step (1), mixing evenly at high speed is performed in a high-speed mixer; and more preferably, a rotational speed of the high-speed mixer is controlled in a range of 300-450 r/min, and a rotational time thereof is controlled in a range of 15-20 min.

Preferably, in the step (2), mixing evenly at high speed is performed in the high-speed mixer; and more preferably, the rotational speed of the high-speed mixer is controlled in the range of 300-450 r/min, and the rotational time thereof is controlled in the range of 15-20 min.

Preferably, in the step (1), extruding is performed by a twin-screw extruder. The twin-screw extruder is able to realize high yield, high quality and high efficiency of composite material preparation, so the twin-screw extruder is used in the present invention.

Preferably, a cylinder of the extruder has a feeding section, a discharge section and at least one middle section, a temperature of the feeding section and the discharge section is 170° C., a temperature of the at least one middle section is 175° C., a rotational speed of a twin-screw is in a range of 100-180 r/min.

More preferably, a cylinder of the extruder has a feeding section, a discharge section and seven middle sections, a temperature of each section from a feeding end to a discharge end is 170° C., 175° C., 175° C., 175° C., 175° C., 175° C., 175° C., 175° C. and 170° C. in sequence.

Preferably, the step (1) further comprises steps of cooling by a sink after extruding, and then pulling to a granulator before granulating, wherein a rotational speed of the granulator is in a range of 200 to 400 r/min.

Preferably, in the step (2), extruding is performed by the twin-screw extruder. The twin-screw extruder is able to realize high yield, high quality and high efficiency of composite material preparation, so the twin-screw extruder is used in the present invention.

Preferably, a cylinder of the twin-screw extruder has a feeding section, a discharge section and at least one middle section, a temperature of the feeding section and the discharge section is 170° C., a temperature of the at least one middle section is 175° C., a rotational speed of a twin-screw is in a range of 100-180 r/min.

More preferably, a cylinder of the twin-screw extruder has a feeding section, a discharge section and seven middle sections, a temperature of each section from a feeding end to a discharge end is 170° C., 175° C., 175° C., 175° C., 175° C., 175° C., 175° C., 175° C. and 170° C. in sequence.

Preferably, the step (2) further comprises steps of cooling by the sink after extruding, and then pulling to the granulator before granulating, wherein the rotational speed of the granulator is in the range of 200 to 400 r/min.

Preferably, a particle size of the masterbatch prepared by the step (1) is controlled in a range of 10 to 15 meshes.

Preferably, a particle size of the asphalt modifier prepared by the step (2) is controlled in a range of 10 to 15 meshes.

Also, the present invention provides a green high viscosity toughness modified asphalt, which includes matrix asphalt and the above green high viscosity toughness asphalt modifier.

Preferably, in the modified asphalt, a weight ratio of the green high viscosity toughness asphalt modifier and the matrix asphalt is in a range of (15-20):(80-85).

Also, the present invention provides a preparation method of the above green high viscosity toughness modified asphalt.

The preparation method of the modified asphalt comprises steps of:
(1) heating the matrix asphalt till melting;
(2) adding the green high viscosity toughness asphalt modifier into the molten matrix asphalt, and stirring with a temperature in a range of 175-180° C., wherein stirring is performed at low speed, such as manual stirring;
(3) shearing at high speed for 20-30 min with a temperature in a range of 175-180° C.;
(4) dispersing the sheared asphalt for 10-15 min at a rotational speed in a range of 300-500 r/min with a temperature in a range of 175-180° C.; and
(5) performing heat preservation on a product of the step (4) with a temperature in a range of 175-185° C., and developing for 60-70 min in a closed state for obtaining the modified asphalt.

In the above preparation method, the step (3) is able to finely grind the asphalt modifier, shearing at high speed is generally performed by a high-speed shear apparatus; the step (4) is able to further disperse the ground asphalt modifier in the matrix asphalt, dispersing at high speed is generally performed in a high-speed stirrer; the step (5) is able to fully develop the asphalt modifier in the matrix asphalt for forming the solid spacial network structure with the matrix asphalt.

Preferably, in the step (1), the matrix asphalt is heated at a temperature in a range of 135 −140° C. for 30-40 min till melting.

Preferably, in the step (3), shearing is performed at a speed in a range of 4500-6000 r/min.

Further, the present invention provides a bituminous concrete, which includes the above green high viscosity toughness modified asphalt or the green high viscosity toughness modified asphalt prepared by the above preparation method, and a mineral material, wherein the green high viscosity toughness modified asphalt is 5% to 6% of the weight of the mineral material.

Preferably, the mineral material includes aggregate and mineral powder, and a porosity of the mineral material is controlled in a range of 3 to 6%.

Further, the present invention provides a preparation method of the above bituminous concrete, which comprises steps of:
(1) weighing the green high viscosity toughness modified asphalt in proportion, and preparing the aggregate and the mineral powder according to mineral grading requirements;
(2) heating the green high viscosity toughness modified asphalt at a temperature in a range of 175° C. to 185° C. for 30-40 min till the modified asphalt is molten, and heating the aggregate for 4-8 h to use; and
(3) stirring the aggregate and the modified asphalt in the step (2) at the temperature in the range of 175° C. to 185° C. for 90-120 s, adding the prepared mineral powder, and stirring at the temperature in the range of 175° C. to 185° C. for 90-120 s again for obtaining the bituminous concrete.

The present invention has some beneficial effects as follows.

(1) By optimizing the formula and preparation process of asphalt modifier, the present invention provides an asphalt modifier, modified asphalt and bituminous concrete. It has the characteristics of low cost, green, low carbon, high viscosity and high toughness.

(2) The present invention provides preparation methods of asphalt modifier, modified asphalt and bituminous concrete by creatively adopting secondary melt blending extrusion method, which better achieves the stripping of layered nano-clay materials, solves the problem that nano-clay materials are difficult to disperse in waste rubber and plastic materials. Meanwhile, the compatibility between the waste rubber and plastic material and asphalt is improved by the nano effect of nano-clay material, so as to enhance the comprehensive performance of asphalt and bituminous concrete.

Since nanomaterial particles have high specific surface energy and surface area, it is easy to agglomerate when the nanomaterial particles are mixed with the waste rubber and plastic mixture in the mixing process. In the present invention, the waste rubber and plastic mixture is firstly mixed with the nano-clay material and the compatilizer, so that the macromolecules are able to be easily inserted into the interlamellar of layered silicates for widening the distance between the nano-clay layers, and the nano-clay material is preliminarily dispersed, so that the masterbatch containing high nano-clay content (in a range of 7.7% to 25%) is prepared by the first melt blending extrusion. Then, the waste rubber and plastic mixture, compatilizer and the prepared masterbatch are directly mixed, and the second melt blending extrusion is performed for further increasing the dispersion of nano-clay material.

(3) The waste rubber and plastic mixture in the raw materials provided by the present invention is an environmentally friendly material, which is able to reduce the material cost, realize the resource utilization and high value utilization of waste rubber and plastics, and realize the research and development of low-cost, green and low-carbon modified asphalt. Therefore, it is very important for the present invention to realize the goal of “double carbon” in the transportation industry.

(4) The nano-clay material in the asphalt modifier provided by the present invention has a layered structure, and the nano-clay material is used as a stabilizer for auxiliary dispersing, which is able to balance the density difference between the waste rubber and plastic material and the matrix asphalt, improve the dispersion and uniformity of the material, and improve the stability of the modified asphalt. Moreover, due to the layered structure of the nano-clay material, both waste rubber and plastic molecules and asphalt molecules are able to be embedded into the layered nano-clay channels to form the solid three-dimensional spatial network structure, thus greatly improving the comprehensive performance of asphalt.

(5) The asphalt modifier, modified asphalt and bituminous concrete provided by the present invention have the characteristics of high viscosity and high toughness. The key index of asphalt modifier, namely, the melt mass flow rate (190° C., 2.16 kg) >10 g/10 min. The key index of modified asphalt, namely, the rotational viscosity at 150° C. is less than 3 Pa·s, the softening point difference at 48 h is less than 0.8° C., the softening point is greater than 100° C., the ductility at 5° C. is greater than 50 cm, the high temperature classification temperature is more than 100° C., and the low temperature classification temperature is up to −24° C.; the dynamic viscosity at 60° C. is more than 500000 Pa·s. The key index of bituminous concrete, namely, the rutting factor at 60° C. is greater than 6000 times/mm, and the low temperature bending failure strain is greater than 3000με. It is suitable for the technical requirements of extremely heavy, extra heavy and heavy load traffic. Therefore, the asphalt modifier, modified asphalt and bituminous concrete provided by the present invention not only ensure excellent construction workability, but also have excellent storage stability, high and low temperature performance. They are able to be applied to pavement layers with strict requirements on binders such as drainage noise pavement, ultra-thin overlay, bridge deck pavement and airport overlay, and have a wide range of applications.

In summary, the asphalt modifier, modified asphalt and bituminous concrete provided by the present invention have the characteristics of low cost, green and low carbon, good stability, wide application range, high viscosity and toughness, high comprehensive performance, simple preparation process, and are suitable for industrial production.

### BRIEF DESCRIPTION OF THE DRAWINGS

FIG. 1 is a microstructure diagram of modified asphalt according to the first embodiment of the present invention.

FIG. 2 is a microstructure diagram of modified asphalt according to the second embodiment of the present invention.

FIG. 3 is a microstructure diagram of modified asphalt according to the third embodiment of the present invention.

FIG. 4 is a microstructure diagram of modified asphalt according to the fourth embodiment of the present invention.

FIG. 5 is a microstructure diagram of modified asphalt according to the first comparative example of the present invention.

FIG. 6 is a microstructure diagram of modified asphalt according to the second comparative example of the present invention.

### DETAILED DESCRIPTION OF THE PREFERRED EMBODIMENT

The terms used in the present invention are explained as below. “Be prepared by . . . ” is synonymous with “contain”. The terms in the present invention, such as “contain”, “include”, “have”, and “comprise”, or any other variations thereof, are intended to cover non-exclusive inclusions. For example, a composition, step, method, article or device containing listed elements need not be limited to these listed elements, but may include other elements not expressly listed or elements inherent in such composition, step, method, article or device.

The phrase “consist of” excludes any elements, steps or components not indicated. If used in a claim, this phrase would make the claim closed, so that it does not contain materials other than those described, except for the conventional impurities associated with it. When the phrase “consist of” appears in a clause of the subject of the claim rather than immediately after the subject, it is limited only to the elements described in the clause, other elements are not excluded from the whole claim.

When the quantity, concentration, or other values or parameters expressed by a range, a preferred range, or a range defined by a series of upper and lower limit preferred values, it should be understood as all ranges formed by any pairing of any upper limit or preferred value with any lower limit or preferred value, regardless of whether the range is separately disclosed or not. For example, when the range of 1 to 5 is disclosed, it should be interpreted that the range of 1 to 4, the range of 1 to 3, the range of 1 to 2, the range of 1 to 2 and 4 to 5, the range of 1 to 3 and 5 and so on are included. When a numeric range is described herein, unless otherwise stated, the numeric range is intended to include its end values and all integers and fractions within the numeric range.

In these embodiments, unless otherwise specified, the described parts and percentages are measured by weight.

“Parts by weight” refers to the basic unit of measurement that represents the weight ratio relationship of multiple components, and one part is able to represent any unit weight, such as 1 g, and 2 g. If there are a parts of component A and b parts of component B, the weight ratio of component A to component B is a:b. Alternatively, it is able to be understood that there are aK parts of component A and bK parts of component B (K is any number and represents a multiple factor). It should not be misunderstood that, unlike weight percentage, the sum of parts of all components by weight is not limited to 100 parts.

“And/or” is used to indicate that either or both of the described circumstances may occur. For example, A and/or B includes (A and B) and (A or B).

In order to facilitate understanding the present invention, a more comprehensive description of the present invention is as below with reference to the relevant drawings. Better embodiments of the present invention are given in the attached drawings. However, the present invention is able to be implemented in many different forms and is not limited to the embodiments described herein. These embodiments are provided for providing a more thorough understanding of the disclosure of the present invention.

Unless otherwise defined, all technical and scientific terms used herein have the same meaning as those commonly understood by a person skilled in the art of the present invention. The terms used in the specification of the present invention are only for explaining specific embodiments and are not intended to limit the present invention. If the specific conditions are not specified in the embodiments, it shall be carried out in accordance with the conventional conditions or those conditions recommended by the manufacturer. The used reagents or instruments, which are not indicated by the manufacturer, are conventional products that are able to be purchased on the market.

### First Embodiment

(I) A green high viscosity toughness asphalt modifier and a preparation method thereof according to the first embodiment of the present invention are provided. The asphalt modifier includes the following raw material components by weight: 232 parts of waste rubber and plastic mixture which specifically consists of 129 parts of waste rubber powder with the particle size of 60 meshes and the content of rubber hydrocarbon larger than 50%, and 103 parts of waste polyethylene with the particle size of 10 meshes; 4 parts of nano-organic montmorillonite; and 28 parts of aromatic oil with the content of aromatic hydrocarbon larger than 80%.

The preparation method of the asphalt modifier comprises steps of:
(1) preparing masterbatch by the first melt blending extrusion, which comprises:
firstly, weighing nano-organic montmorillonite, waste rubber and plastic mixture and aromatic oil with the weight ratio of 1:4:1, mixing evenly in a high-speed mixer at the rotational speed of 450 r/min for 15 min;
and then, extruding by a twin-screw extruder, cooling by a sink, pulling to a granulator, and granulating for preparing the masterbatch, wherein a cylinder of the extruder has a feeding section, a discharge section and seven middle sections, the temperature of each section from a feeding end to a discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the masterbatch is controlled in the range of 10 to 15 meshes; and
(2) performing the second melt blending extrusion, which comprises:
firstly, mixing evenly the waste rubber and plastic mixture, the masterbatch obtained by the step (1) and the aromatic oil with the weight ratio of 9:1:1 in the high-speed mixer at the rotational speed of 450 r/min for 15 min;
and then, extruding by the twin-screw extruder, cooling by the sink, pulling to the granulator, and granulating for obtaining the asphalt modifier, wherein the cylinder of the extruder has a feeding section, a discharge section and seven middle sections, the temperature of each section from the feeding end to the discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the green high viscosity toughness asphalt modifier is controlled in the range of 10 to 15 meshes.

(II) Also, a green high viscosity toughness modified asphalt and a preparation method thereof according to the first embodiment of the present invention are provided. The modified asphalt includes the following raw material components by weight: 85 parts of 70 #matrix asphalt and 15 parts of the above prepared green high viscosity toughness asphalt modifier.

The preparation method of the modified asphalt comprises steps of:
(1) melting the matrix asphalt by heating at 135° C. in an oven for 40 min;
(2) putting the molten matrix asphalt on an electromagnetic heating device, adding the green high viscosity toughness asphalt modifier into the molten matrix asphalt, and stirring manually for 15 min with the temperature of 180° C.;
(3) shearing at the speed of 4500 r/min for 30 min by a high-speed shear apparatus with the temperature of 180° C.;
(4) dispersing the sheared asphalt by a high-speed stirrer for 15 min at the rotational speed of 300 r/min with the temperature of 180° C.; and
(5) developing for 70 min at 180° C. after putting the dispersed asphalt in a closed oven for obtaining the green high viscosity toughness modified asphalt.

(III) Also, a preparation method of green high viscosity toughness bituminous concrete according to the first embodiment of the present invention is provided. The preparation method of the bituminous concrete comprises steps of:
(1) weighing the following raw material components by weight: 5 parts of the above prepared green high viscosity toughness modified asphalt, 94 parts of aggregate, and 6 parts of mineral powder, wherein the aggregate and the mineral powder are prepared according to the gradation of AC-13 graded asphalt mixture shown in Table 1, the porosity is controlled in the range of 3% to 6%, and the sieve size of the mineral powder is below 0.075 mm;
(2) heating the green high viscosity toughness modified asphalt at the temperature in the range of 175° C. to 185° C. for 30-40 min till the modified asphalt is molten, and heating the aggregate for more than 4 h to use; and
(3) stirring the aggregate and the modified asphalt in the step (2) at the temperature in the range of 175° C. to 185° C. for 90-120 s, adding the prepared mineral powder, and stirring at the temperature in the range of 175° C. to 185° C. for 90-120 s again for obtaining the bituminous concrete.

### Second Embodiment

(I) A green high viscosity toughness asphalt modifier and a preparation method thereof according to the second embodiment of the present invention are provided. The asphalt modifier includes the following raw material components by weight: 112 parts of waste rubber and plastic mixture which specifically consists of 62 parts of waste rubber powder with the particle size of 100 meshes and the content of rubber hydrocarbon larger than 50%, and 50 parts of waste polypropylene with the particle size of 10 meshes; 4 parts of nano-rectorite; and 16 parts of aromatic oil with the content of aromatic hydrocarbon larger than 80%.

The preparation method of the asphalt modifier comprises steps of:
(1) preparing masterbatch by the first melt blending extrusion, which comprises: firstly, weighing nano-rectorite, waste rubber and plastic mixture and aromatic oil with the weight ratio of 1:4:1, mixing evenly in a high-speed mixer at the rotational speed of 450 r/min for 15 min;
and then, extruding by a twin-screw extruder, cooling by a sink, pulling to a granulator, and granulating for preparing the masterbatch, wherein a cylinder of the extruder has a feeding section, a discharge section and seven middle sections, the temperature of each section from a feeding end to a discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the masterbatch is controlled in the range of 10 to 15 meshes; and

(2) performing the second melt blending extrusion, which comprises:
firstly, mixing evenly the waste rubber and plastic mixture, the masterbatch obtained by the step (1) and the aromatic oil with the weight ratio of 8:2:1 in the high-speed mixer at the rotational speed of 450 r/min for 15 min;
and then, extruding by the twin-screw extruder, cooling by the sink, pulling to the granulator, and granulating for obtaining the asphalt modifier, wherein the cylinder of the extruder has a feeding section, a discharge section and seven middle sections, the temperature of each section from the feeding end to the discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the green high viscosity toughness asphalt modifier is controlled in the range of 10 to 15 meshes.

(II) Also, a green high viscosity toughness modified asphalt and a preparation method thereof according to the second embodiment of the present invention are provided. The modified asphalt includes the following raw material components by weight: 85 parts of 70 #matrix asphalt and 15 parts of the above prepared green high viscosity toughness asphalt modifier.

The preparation method of the modified asphalt comprises steps of:
(1) melting the matrix asphalt by heating at 135° C. in an oven for 40 min;
(2) putting the molten matrix asphalt on an electromagnetic heating device, adding the green high viscosity toughness asphalt modifier into the molten matrix asphalt, and stirring manually for 15 min with the temperature of 180° C.;
(3) shearing at the speed of 4500 r/min for 30 min by a high-speed shear apparatus with the temperature of 180° C.;
(4) dispersing the sheared asphalt by a high-speed stirrer for 15 min at the rotational speed of 300 r/min with the temperature of 180° C.; and
(5) developing for 70 min at 180° C. after putting the dispersed asphalt in a closed oven for obtaining the green high viscosity toughness modified asphalt.

(III) Also, a preparation method of green high viscosity toughness bituminous concrete according to the second embodiment of the present invention is provided. The bituminous concrete includes the following raw material components by weight: 5 parts of the above prepared green high viscosity toughness modified asphalt, 94 parts of aggregate, and 6 parts of mineral powder, wherein the aggregate and the mineral powder are prepared according to the gradation of AC-13 graded asphalt mixture shown in Table 1, the porosity is controlled in the range of 3% to 6%, and the sieve size of the mineral powder is below 0.075 mm. The preparation method of the bituminous concrete refers to the first embodiment.

### Third Embodiment

(I) A green high viscosity toughness asphalt modifier and a preparation method thereof according to the third embodiment of the present invention are provided. The asphalt modifier includes the following raw material components by weight: 90 parts of waste rubber and plastic mixture which specifically consists of 50 parts of waste rubber powder with the particle size of 120 meshes and the content of rubber hydrocarbon larger than 50%, and 40 parts of waste polypropylene with the particle size of 10 meshes; 5 parts of nano-vermiculite; and 15 parts of aromatic oil with the content of aromatic hydrocarbon larger than 80%.

The preparation method of the asphalt modifier comprises steps of:
(1) preparing masterbatch by the first melt blending extrusion, which comprises: firstly, weighing nano-vermiculite, waste rubber and plastic mixture and aromatic oil with the weight ratio of 1:4:1, mixing evenly in a high-speed mixer at the rotational speed of 450 r/min for 15 min;
and then, extruding by a twin-screw extruder, cooling by a sink, pulling to a granulator, and granulating for preparing the masterbatch, wherein a cylinder of the extruder has a feeding section, a discharge section and seven middle sections, the temperature of each section from a feeding end to a discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the masterbatch is controlled in the range of 10 to 15 meshes; and

(2) performing the second melt blending extrusion, which comprises:
firstly, mixing evenly the waste rubber and plastic mixture, the masterbatch obtained by the step (1) and the aromatic oil with the weight ratio of 7:3:1 in the high-speed mixer at the rotational speed of 450 r/min for 15-20 min;
and then, extruding by the twin-screw extruder, cooling by the sink, pulling to the granulator, and granulating for obtaining the asphalt modifier, wherein the cylinder of the extruder has a feeding section, a discharge section and seven middle sections, the temperature of each section from the feeding end to the discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the green high viscosity toughness asphalt modifier is controlled in the range of 10 to 15 meshes.

(II) Also, a green high viscosity toughness modified asphalt and a preparation method thereof according to the third embodiment of the present invention are provided. The modified asphalt includes the following raw material components by weight: 85 parts of 70 #matrix asphalt and 15 parts of the above prepared green high viscosity toughness asphalt modifier.

The preparation method of the modified asphalt comprises steps of:
(1) melting the matrix asphalt by heating at 135° C. in an oven for 40 min;
(2) putting the molten matrix asphalt on an electromagnetic heating device, adding the green high viscosity toughness asphalt modifier into the molten matrix asphalt, and stirring manually for 15 min with the temperature of 180° C.;
(3) shearing at the speed of 4500 r/min for 30 min by a high-speed shear apparatus with the temperature of 180° C.;
(4) dispersing the sheared asphalt by a high-speed stirrer for 15 min at the rotational speed of 300 r/min with the temperature of 180° C.; and
(5) developing for 70 min at 180° C. after putting the dispersed asphalt in a closed oven for obtaining the green high viscosity toughness modified asphalt.

(III) Also, a preparation method of green high viscosity toughness bituminous concrete according to the third embodiment of the present invention is provided. The bituminous concrete includes the following raw material components by weight: 5 parts of the above prepared green high viscosity toughness modified asphalt, 94 parts of aggregate, and 6 parts of mineral powder, wherein the aggregate and the mineral powder are prepared according to the gradation of AC-13 graded asphalt mixture shown in Table 1, the porosity is controlled in the range of 3% to 6%, and the sieve size of the mineral powder is below 0.075 mm. The preparation method of the bituminous concrete refers to the first embodiment.

### Fourth Embodiment

(I) A green high viscosity toughness asphalt modifier and a preparation method thereof according to the fourth embodiment of the present invention are provided. The asphalt modifier includes the following raw material components by weight: 70 parts of waste rubber and plastic mixture which specifically consists of 28 parts of waste rubber powder with the particle size of 120 meshes and the content of rubber hydrocarbon larger than 50%, and 42 parts of waste polypropylene with the particle size of 10 meshes (the weight ratio is 1:1.5); 10 parts of nano-organic montmorillonite; and 50 parts of aromatic oil with the content of aromatic hydrocarbon larger than 80%.

The preparation method of the asphalt modifier comprises steps of:
(1) preparing masterbatch by the first melt blending extrusion, which comprises:
firstly, weighing nano-organic montmorillonite, waste rubber and plastic mixture and aromatic oil with the weight ratio of 1:2:2, mixing evenly in a high-speed mixer at the rotational speed of 300 r/min for 15 to 20 min;
and then, extruding by a twin-screw extruder, cooling by a sink, pulling to a granulator, and granulating for preparing the masterbatch, wherein a cylinder of the extruder has a feeding section, a discharge section and seven middle sections, the temperature of each section from a feeding end to a discharge end is 170° C., 175° C., 175° C., 175° C., 175° C., 175° C., 175° C., 175° C., and 170° C. in sequence, the rotational speed of the twin-screw is 180 r/min, the rotational speed of the granulator is 400 r/min, and the particle size of the masterbatch is controlled in the range of 10 to 15 meshes; and
(2) performing the second melt blending extrusion, which comprises:
firstly, mixing evenly the waste rubber and plastic mixture, the masterbatch obtained by the step (1) and the aromatic oil with the weight ratio of 5:5:3 in the high-speed mixer at the rotational speed of 300 r/min for 15-20 min;
and then, extruding by the twin-screw extruder, cooling by the sink, pulling to the granulator, and granulating for obtaining the asphalt modifier, wherein the cylinder of the extruder has a feeding section, a discharge section and seven middle sections, the temperature of each section from the feeding end to the discharge end is 170° C., 175° C., 175° C., 175° C., 175° C., 175° C., 175° C., 175° C., and 170° C. in sequence, the rotational speed of the twin-screw is 180 r/min, the rotational speed of the granulator is 400 r/min, and the particle size of the green high viscosity toughness asphalt modifier is controlled in the range of 10 to 15 meshes.

(II) Also, a green high viscosity toughness modified asphalt and a preparation method thereof according to the fourth embodiment of the present invention are provided. The modified asphalt includes the following raw material components by weight: 80 parts of 70 #matrix asphalt and 20 parts of the above prepared green high viscosity toughness asphalt modifier.

The preparation method of the modified asphalt comprises steps of:
(1) melting the matrix asphalt by heating at 140° C. in an oven for 30 min;
(2) putting the molten matrix asphalt on an electromagnetic heating device, adding the green high viscosity toughness asphalt modifier into the molten matrix asphalt, and stirring manually for 15 min with the temperature of 175° C.;
(3) shearing at the speed of 6000 r/min for 20 min by a high-speed shear apparatus with the temperature of 175° C.;
(4) dispersing the sheared asphalt by a high-speed stirrer for 10 min at the rotational speed of 500 r/min with the temperature of 185° C.; and
(5) developing for 60 min at 185° C. after putting the dispersed asphalt in a closed oven for obtaining the green high viscosity toughness modified asphalt.

(III) Also, a preparation method of green high viscosity toughness bituminous concrete according to the fourth embodiment of the present invention is provided. The bituminous concrete includes the following raw material components by weight: 6 parts of the above prepared green high viscosity toughness modified asphalt, 94 parts of aggregate, and 6 parts of mineral powder, wherein the aggregate and the mineral powder are prepared according to the gradation of AC-13 graded asphalt mixture shown in Table 1, the porosity is controlled in the range of 3% to 6%, and the sieve size of the mineral powder is below 0.075 mm. The preparation method of the bituminous concrete refers to the first embodiment.

### First Comparative Example

The difference between the first embodiment and the first comparative example is that one-time melt blending extrusion is used in the first comparative example. The preparation methods of the asphalt modifier, the modified asphalt and the bituminous concrete are respectively as follows.

### (I) Preparation of the Asphalt Modifier

The asphalt modifier includes the following raw material components by weight: 232 parts of waste rubber and plastic mixture which specifically consists of 129 parts of waste rubber powder with the particle size of 60 meshes and the content of rubber hydrocarbon larger than 50%, and 103 parts of waste polyethylene with the particle size of 10 meshes; 4 parts of nano-organic montmorillonite; and 28 parts of aromatic oil with the content of aromatic hydrocarbon larger than 80%.

The asphalt modifier is prepared by one-time melt blending extrusion, which comprises steps of:
firstly, weighing the nano-organic montmorillonite, waste rubber and plastic mixture and aromatic oil according to the above parts by weight, mixing evenly in a high-speed mixer at the rotational speed of 450 r/min for 15 min;
and then, extruding by a twin-screw extruder, cooling by a sink, pulling to a granulator, and granulating for obtaining the asphalt modifier, wherein a cylinder of the extruder has a feeding section, a discharge section and seven middle sections, the temperature of each section from a feeding end to a discharge end is 170° C., 175° C., 175° C., 175° C., 175° C., 175° C., 175° C., 175° C., and 170° C. in sequence, the rotational speed of the twin-screw is 120 r/min, the rotational speed of the granulator is 200 r/min, and the particle size of the masterbatch is controlled in the range of 10 to 15 meshes.

### (II) Preparation of the Modified Asphalt

The modified asphalt is prepared by the preparation method according to the first embodiment of the present invention. The modified asphalt includes the following raw material components by weight: 85 parts of 70 #matrix asphalt and 15 parts of the above prepared asphalt modifier.

### (III) Preparation of the Bituminous Concrete

The bituminous concrete includes the following raw material components by weight: 5 parts of the above prepared modified asphalt, 94 parts of aggregate, and 6 parts of mineral powder, wherein the aggregate and the mineral powder are prepared according to the gradation of AC-13 graded asphalt mixture shown in Table 1, the porosity is controlled in the range of 3% to 6%, and the sieve size of the mineral powder is below 0.075 mm. The preparation method of the bituminous concrete refers to the first embodiment.

### Second Comparative Example

TPS (TAFPACK-Super), a representative high viscosity asphalt modifier from Japan, is used as the asphalt modifier in the second comparative example of the present invention. Its main components are thermoplastic rubber, plasticizer, etc. Its disadvantage is expensive.

The modified asphalt, according to the second comparative example of the present invention, is prepared by the preparation method provided by the first embodiment of the present invention. It includes the following raw material components by weight: 85 parts of 70 #matrix asphalt and 15 parts of the high viscosity asphalt modifier TPS.

Also, the second comparative example provides a preparation method of the bituminous concrete. The bituminous concrete includes the following raw material components by weight: 5 parts of the above prepared modified asphalt, 94 parts of aggregate, and 6 parts of mineral powder, wherein the aggregate and the mineral powder are prepared according to the gradation of AC-13 graded asphalt mixture shown in Table 1, the porosity is controlled in the range of 3% to 6%, and the sieve size of the mineral powder is below 0.075 mm. The preparation method of the bituminous concrete refers to the first embodiment.

### Performance Test:

(I) The microstructure of the green high viscosity toughness modified asphalt prepared by the first to fourth embodiments and the microstructure of the modified asphalt prepared by the first and second comparative examples are characterized by fluorescence microscopy.

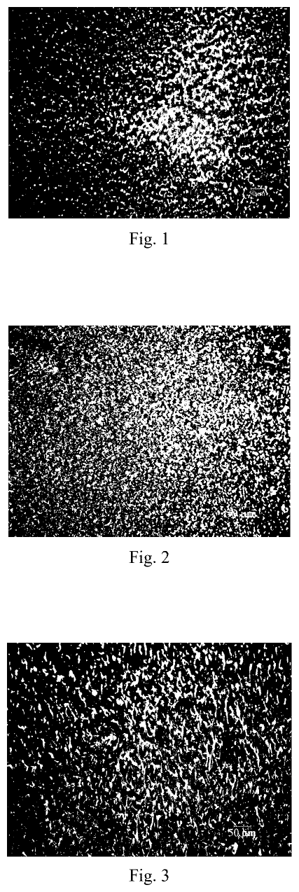

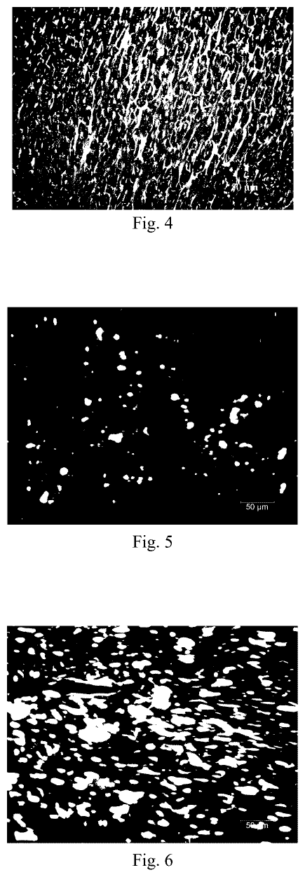

FIGS. 1 to 4 are microstructure diagrams of the modified asphalt provided by the first to fourth embodiments. FIG. 5 is a microstructure diagram of the modified asphalt provided by the first comparative example. FIG. 6 is a microstructure diagram of the modified asphalt provided by the second comparative example. In FIGS. 1 to 6, black represents matrix asphalt, and white represents asphalt modifier.

It is able to be seen from FIGS. 1 to 4 that each of these four green high viscosity toughness asphalt modifiers is dispersed evenly in the matrix asphalt, and forms a solid three-dimensional spatial network structure, so that the comprehensive performances of asphalt are able to be greatly improved.

It is able to be seen from FIGS. 5 and 6 corresponding to the first and second comparative examples that: the asphalt modifiers provided by the first and second comparative examples are unable to disperse evenly in the matrix asphalt, and particles of the modifier are agglomerated. As a result, the performance of asphalt is affected.

(II) According to “Determination of Melt Mass Flow Rate (MFR) and Melt Volume Flow Rate (MVR) of Plastic Thermoplastics—Part 1: Standard Method” (GB/T3682.1-2018), the melt mass flow rates of the asphalt modifiers provided by the first to fourth embodiments and the first and second comparative examples are tested. The key indexes of the modified asphalt provided by the first to fourth embodiments and the first and second comparative examples are tested by the relevant test methods in “Highway Engineering Asphalt and Asphalt Mixture Test Specification” (JTG E20-2011).

(III) The bituminous concrete provided by the first to fourth embodiments and the first and second comparative examples are put into a rutting machine for forming, so that a rutting board with a length of 300 mm, a width of 300 mm and a height of 50 mm is obtained, for testing and evaluating the low temperature performance of the bituminous concrete. The formed rutting board is cut into a prism with a length of 250 mm±2.0 mm, a width of 30 mm±2.0 mm, and a height of 35 mm±2.0 mm for testing and evaluating the high temperature performance of the bituminous concrete. The high and low temperature performance indexes of the bituminous concrete are tested by the relevant test methods in “Highway Engineering Asphalt and Asphalt Mixture Test Specification” (JTG E20-2011).

Test results are shown in Table 1.

TABLE 1
Test results of performance indexes of asphalt modifier, modified asphalt and bituminous concrete
provided by the first to fourth embodiments and the first and second comparative examples

| | | | | | | | | | Technical |
|---|---|---|---|---|---|---|---|---|---|
| Index | | Unit | E1 | E2 | E3 | E4 | C1 | C2 | Requirement |
| Asphalt | Melt mass | g/10 min | 13.28 | 14.58 | 15.78 | 18.88 | 2.5 | 3.18 | >2 |
| modifier | flow rate | | | | | | | | |
| | (190° C., | | | | | | | | |
| | 2.16 kg) | | | | | | | | |
| Modified | Penetration | 0.1 mm | 46 | 43 | 42 | 40 | 44 | 45 | 40-70 |
| asphalt | degree | | | | | | | | |
| | (25° C., | | | | | | | | |
| | 100 g, 5 s) | | | | | | | | |
| | Softening | ° C. | 101 | 105 | 108 | 115 | 85 | 90 | ≥90 |
| | point | | | | | | | | |
| | Ductility | cm | 42 | 48 | 53 | 59 | 26 | 30 | ≥40 |
| | (5° C., | | | | | | | | |
| | 5 cm/min) | | | | | | | | |
| | Temperature | ° C. | 150 | 150 | 150 | 150 | 175 | 175 | 165 |
| | when the | | | | | | | | |
| | kinematic | | | | | | | | |
| | viscosity is | | | | | | | | |
| | less than | | | | | | | | |
| | 3 Pa · s | | | | | | | | |
| | Kinematic | 10 KPa · s | 75 | 82 | 101 | 110 | 13.2 | 14.4 | ≥20 |
| | viscosity at | | | | | | | | |
| | 60° C. | | | | | | | | |
| | Segregation, | ° C. | 0.50 | 0.60 | 0.65 | 0.65 | 4.5 | 2.4 | ≤2.5 |
| | 48 h softening | | | | | | | | |
| | point | | | | | | | | |
| | difference | | | | | | | | |
| | Mass loss | % | 0.01 | 0.02 | 0.03 | 0.03 | 0.8 | 0.5 | ±1 |
| | Critical | ° C. | 100 | 106 | 106 | 112 | 88 | 88 | / |
| | temperature | | | | | | | | |
| | when rutting | | | | | | | | |
| | factor ≥2.2 | | | | | | | | |
| | kPa | | | | | | | | |
| | Critical | ° C. | −24 | −24 | −24 | −24 | −12 | −12 | / |
| | temperature | | | | | | | | |
| | when creep | | | | | | | | |
| | rate >0.3 | | | | | | | | |
| | and creep | | | | | | | | |
| | stiffness <300 | | | | | | | | |
| | MPa | | | | | | | | |
| Bituminous | Rutting test at | times/mm | 6500 | 7600 | 9600 | 10100 | 4200 | 4500 | ≥2400 |
| concrete | 60° C. | | | | | | | | |
| | Low | με | 4100 | 4500 | 4800 | 5100 | 3300 | 3500 | ≥3000 |
| | temperature | | | | | | | | |
| | bending | | | | | | | | |
| | failure strain | | | | | | | | |
| | at −10° C. | | | | | | | | |

Here, E1 represents the first embodiment, E2 represents the second embodiment, E3 represents the third embodiment, E4 represents the fourth embodiment, C1 represents the first comparative example, and C2 represents the second comparative example.

Note: Technical requirements refer to “Technical Specification for Prevention and Maintenance of Highway Asphalt Pavement” (JTG/T 5142-01-2021) and “Technical Specifications for Construction of Highway Asphalt Pavement” (JTG/T 5142-01-2021).

It is able to known from Table 1 that the green high viscosity toughness asphalt modifier has excellent flow performance and processing performance, which lays a foundation for the preparation of modified asphalt in the later stage. The green high viscosity toughness modified asphalt has good construction workability, forms the solid three-dimensional spatial network structure, and has excellent storage stability, high and low temperature rheological properties, anti-aging properties and bonding properties. Moreover, the prepared bituminous concrete has excellent high and low temperature pavement performance, so the service life of traditional asphalt pavement is significantly improved.

The above is only a partial better embodiment of the present invention, and is not used to limit the present invention. Any modification, equivalent replacement, improvement, etc. made within the spirit and principles of the present invention shall be included in the protection scope of the present invention.

What is claimed is:

1. A green high viscosity toughness asphalt modifier, which comprises following raw material components by weight:
70-232 parts of waste rubber and plastic mixture;
4-10 parts of nano-clay material; and
15-50 parts of compatilizer, wherein:
the waste rubber and plastic mixture consists of waste rubber and waste plastics with a mass ratio in a range of 1:(0.8-1.5);
the waste rubber is waste rubber powder with a particle size in a range of 40 to 120 meshes, wherein a content of rubber hydrocarbon in the waste rubber is larger than 50%;
the waste plastics are waste polyethylene particles or waste polypropylene particles with a particle size in a range of 10 to 15 meshes;
the nano-clay material is at least one member selected from a group consisting of nano-organic montmorillonite, nano-rectorite, and nano-vermiculite;
the asphalt modifier is prepared by secondary melt blending extrusion method, wherein the secondary melt blending extrusion method comprises steps of:
(1) preparing masterbatch by a first melt blending extrusion, which comprises weighing the nano-clay material, the waste rubber and plastic mixture and the compatilizer in accordance with a weight ratio of 1:(2-4):(1-2), mixing evenly at high speed, extruding and granulating for obtaining the masterbatch; and
(2) performing a second melt blending extrusion, which comprises mixing evenly the waste rubber and plastic mixture, the masterbatch obtained by the step (1) and the compatilizer with a weight ratio of (5-9):(1-5):(1-3) at high speed, extruding and granulating for obtaining the asphalt modifier.

2. The green high viscosity toughness asphalt modifier according to claim 1, wherein the compatilizer is aromatic oil with a content of aromatic hydrocarbon larger than 80%.

3. The green high viscosity toughness asphalt modifier according to claim 1, wherein in the step (1), mixing evenly at high speed is performed in a high-speed mixer, a rotational speed of the high-speed mixer is controlled in a range of 300-450 r/min, and a rotational time thereof is controlled in a range of 15-20 min.

4. The green high viscosity toughness asphalt modifier according to claim 1, wherein in the step (2), mixing evenly at high speed is performed in a high-speed mixer, a rotational speed of the high-speed mixer is controlled in a range of 300-450 r/min, and a rotational time thereof is controlled in a range of 15-20 min.

5. The green high viscosity toughness asphalt modifier according to claim 1, wherein in the step (1), extruding is performed by a twin-screw extruder; a cylinder of the twin-screw extruder has a feeding section, a discharge section and at least one middle section, a temperature of the feeding section and the discharge section is 170° C., a temperature of the at least one middle section is 175° C., and a rotational speed of a twin-screw is in a range of 100-180 r/min.

6. The green high viscosity toughness asphalt modifier according to claim 1, wherein in the step (2), extruding is performed by a twin-screw extruder; a cylinder of the twin-screw extruder has a feeding section, a discharge section and at least one middle section, a temperature of the feeding section and the discharge section is 170° C., a temperature of the at least one middle section is 175° C., and a rotational speed of a twin-screw is in a range of 100-180 r/min.

7. The green high viscosity toughness asphalt modifier according to claim 1, wherein:
the step (1) further comprises steps of cooling by a sink after extruding, and then pulling to a granulator before granulating, wherein a rotational speed of the granulator is in a range of 200 to 400 r/min;
the step (2) further comprises steps of cooling by the sink after extruding, and then pulling to the granulator before granulating, wherein the rotational speed of the granulator is in the range of 200 to 400 r/min.

8. The green high viscosity toughness asphalt modifier according to claim 1, wherein a particle size of the masterbatch prepared by the step (1) is controlled in a range of 10 to 15 meshes, and a particle size of the asphalt modifier prepared by the step (2) is controlled in a range of 10 to 15 meshes.

9. A green high viscosity toughness modified asphalt, which comprises matrix asphalt and the green high viscosity toughness asphalt modifier according to claim 1, wherein a weight ratio of the green high viscosity toughness asphalt modifier and the matrix asphalt is in a range of (15-20):(80-85).

10. A preparation method of the green high viscosity toughness modified asphalt according to claim 9, wherein the preparation method comprises steps of:
(1) heating the matrix asphalt till melting;
(2) adding the green high viscosity toughness asphalt modifier into the molten matrix asphalt, and stirring with a temperature in a range of 175-180° C.;
(3) shearing at high speed for 20-30 min with a temperature in a range of 175-180° C.;
(4) dispersing the sheared asphalt for 10-15 min at a rotational speed in a range of 300-500 r/min with a temperature in a range of 175-180° C.; and
(5) performing heat preservation on a product of the step (4) with a temperature in a range of 175-185° C., and developing for 60-70 min in a closed state for obtaining the modified asphalt.

11. The preparation method according to claim 10, wherein:
in the step (1), the matrix asphalt is heated at a temperature in a range of 135-140° C. for 30-40 min till melting; and
in the step (2), shearing is performed at a speed in a range of 4500-6000 r/min.
